(19) United States
(12) Patent Application Publication
(10) Pub. No.: US 2025/0386847 A1
(43) Pub. Date: Dec. 25, 2025

(54) COATED HYDROPHOBIC POLYPHENOL NANOPARTICLES, PREPARATION METHOD THEREFOR AND APPLICATION THEREOF

(71) Applicant: Zhejiang University of Technology, Hangzhou (CN)

(72) Inventors: Ping Shao, Hangzhou (CN); Yiyang Chai, Hangzhou (CN); Ying Zhou, Hangzhou (CN)

(21) Appl. No.: 18/898,736

(22) Filed: Sep. 27, 2024

(30) Foreign Application Priority Data
Jun. 21, 2024 (CN) 202410811273.8

(51) Int. Cl. A23P 20/10; A23L 29/231; A23L 33/105; A23L 33/165

(52) U.S. Cl. CPC A23P 20/10; A23L 29/231; A23L 33/105; A23L 33/165

(57) ABSTRACT

The present invention discloses coated hydrophobic polyphenol nanoparticles, preparation method therefor and application thereof. The preparation method for coated hydrophobic polyphenol nanoparticles includes: (1) obtaining a hydrophobic polyphenol nanoparticles suspension; (2) injecting a catechin aqueous solution and a metal salt aqueous solution into the hydrophobic polyphenol nanoparticles suspension to obtain a composite nanoparticles suspension; (3) removing excess catechin and metal ions from the composite nanoparticles suspension to obtain a coated hydrophobic polyphenol nanoparticles suspension. The present invention provides an application of the coated hydrophobic polyphenol nanoparticles in the preparation of pectin gel. The coated hydrophobic polyphenol nanoparticles exhibit significantly enhanced biological activity and long-term stability, developing a pectin gel with long-term stability.

### CROSS-REFERENCE TO RELATED APPLICATION

The present application claims priority from Chinese Patent Application No. 202410811273.8 filed on Jun. 21, 2024, the contents of which are incorporated herein by reference in their entirety.

### TECHNICAL FIELD

This invention pertains to the field of food processing, specifically relating to coated hydrophobic polyphenol nanoparticles, preparation method therefor and application thereof.

### BACKGROUND OF THE INVENTION

Hydrophobic polyphenols, such as resveratrol, curcumin, and quercetin, exist in many natural plant-based foods and possess functional activities including anti-inflammatory, anti-cancer, antioxidant, and cardiovascular protection, which have attracted widespread attention in fields related to food and biomedicine. However, hydrophobic polyphenol compounds generally exhibit poor dispersibility in water and have limited stability in environments with light, oxygen, high ionic strength, temperature, and acidity or alkalinity, which hinders their widespread application as functional foods. To overcome these limitations, many scholars have attempted to encapsulate and deliver these sensitive polyphenol compounds by designing and constructing biobased nanodelivery carriers. In particular, nanoparticle-based drug delivery systems are considered excellent carriers for hydrophobic bioactive polyphenols. These systems can not only enhance the physical stability of hydrophobic phenolic compounds but also enhance their bioactivity, sparking increasing interest in the food and pharmaceutical industries. In recent years, various nanoparticle delivery systems coated with natural active substances such as proteins, polysaccharides, and lipids have received widespread attention due to their natural renewability, safety, biodegradability, and excellent biocompatibility, making them suitable for the development of hydrophobic polyphenol nanoparticles.

Patent CN117502515A discloses a nano-delivery carrier for hydrophobic phenolic compounds and its application in functional dairy products. The nano-delivery carrier is prepared by embedding bioactive polyphenols in a casein-based nanoemulsion, which improves the loading rate. This nano-delivery carrier is prepared through simple dissolution stirring and high-pressure homogenization. However, during the preparation process, hydrophobic polyphenols are easily affected by conditions such as light and heat, leading to nutrient decomposition and reducing the stability of hydrophobic polyphenols. Patent CN115737596A discloses a gliadin particle co-loaded with curcumin and resveratrol and its preparation method. By adding gliadin, the hydrophobic polyphenols are dissolved under alkaline conditions and form intermolecular interactions, which then aggregate under neutral conditions. This method is prone to causing loss of active ingredients and cannot exert an antioxidant effect for a long time.

The present invention selects hydrophilic polyphenol catechin to self-assemble with metal ions to form a supramolecular coating on the surface of hydrophobic polyphenol nanoparticles, resulting in nanoparticles with uniform particle size and long-term colloidal stability, which enhances the bioactivity and bioavailability of the hydrophobic polyphenol. Additionally, the nanoparticles are applied in gels to design functional gels containing hydrophobic polyphenol, thereby broadening the application scope of gels. This invention is expected to provide a new nano-delivery system for hydrophobic polyphenols.

### BRIEF SUMMARY OF THE INVENTION

Addressing the aforementioned issues, the purpose of the present invention is to provide coated hydrophobic polyphenol nanoparticles, preparation method therefor, and application thereof. The coated hydrophobic polyphenol nanoparticles prepared according to this invention exhibit significantly enhanced biological activity and long-term stability. When applied in the preparation of a pectin gel, this coated hydrophobic polyphenol nanoparticle can improve the mechanical properties and biological activity of the pure pectin gel, providing a foundation for the development of functional plant-based gels.

To address the aforementioned technical problem, the present invention adopts the following technical solutions:

The first aspect of the invention provides a preparation method for coated hydrophobic polyphenol nanoparticles, comprising the following steps:
(1) injecting an ethanol solution of a hydrophobic polyphenol into an aqueous solution of PVP, and stirring thoroughly to obtain a suspension of hydrophobic polyphenol nanoparticles; wherein the feeding mass ratio of the hydrophobic polyphenol to PVP is 1:1.5;
(2) rapidly injecting an aqueous solution of catechin with a concentration of 40-50 mg/mL and an aqueous solution of metal salt with a concentration of 10-15 mg/mL into the suspension of hydrophobic polyphenol nanoparticles obtained in step (1) under ultrasonic condition to obtain a suspension of composite nanoparticles; wherein the metal salt is ethylenediaminetetraacetic acid ferric sodium salt or calcium chloride, the feeding ratio of the aqueous solution of catechin, the aqueous solution of metal salt, and the suspension of hydrophobic polyphenol nanoparticles is calculated based on the mass ratio of catechin, the metal salt, and the hydrophobic polyphenol contained therein, which is 4-5:1-1.5:1;
(3) using high-purity water as the dispersing agent, subjecting the suspension of composite nanoparticles obtained in step (2) to cyclic treatment through centrifugation/redispersion to remove excess catechin and metal ions; then redispersing the obtained precipitate in high-purity water to obtain a suspension of coated hydrophobic polyphenol nanoparticles, namely, a suspension of catechin-metal supramolecular coated hydrophobic polyphenol nanoparticles.

Preferably, the hydrophobic polyphenol is resveratrol, curcumin, or quercetin.

Preferably, in step (1), the concentration of the ethanol solution of the hydrophobic polyphenol is 10-12 mg/mL; and the concentration of the aqueous solution of PVP is 0.3-0.5 mg/mL.

The second aspect of the invention provides coated hydrophobic polyphenol nanoparticles obtained by the preparation method according to the first aspect.

The third aspect of the invention provides the application of the coated hydrophobic polyphenol nanoparticles described in the second aspect in the preparation of a pectin gel, including the following steps:
(a) adding pectin to the suspension of coated hydrophobic polyphenol nanoparticles for dissolution to obtain a mixture;
(b) preparing an aqueous solution of sweetener;
(c) mixing the mixture prepared in step (a) with the aqueous solution of the sweetener prepared in step (b) evenly, adding citric acid dropwise to adjust the pH to between 2 and 3, mixing uniformly, and pouring the mixture into a mold for gel formation to obtain a pectin gel containing coated hydrophobic polyphenol nanoparticles.

Preferably, the pectin is high-methoxyl pectin.

Preferably, the feeding ratio of pectin to coated hydrophobic polyphenol nanoparticles is calculated based on the mass ratio of pectin to the hydrophobic polyphenol contained in the coated hydrophobic polyphenol nanoparticles, which is 3:0.006-0.015.

Preferably, the sweetener is a combination of glucose and white sugar, with a mass ratio of 1:0.5-0.75.

Preferably, the feeding ratio of the mixture prepared in step (a) to the aqueous solution of sweetener prepared in step (b) is calculated based on the mass ratio of pectin to sweetener, which is 3:30-45.

By adopting the aforementioned technology, compared with the prior art, the beneficial effects of the present invention are as follows:
1. In the present invention, the hydrophobic polyphenol is used as the nano-“core,” and Fe/Ca-catechin supramolecular structure is coated on the surface of the hydrophobic polyphenol as the “shell.” The bioactivity of the obtained coated hydrophobic polyphenol nanoparticles is significantly enhanced and exhibits long-term stability.

Specifically, the supramolecular structure formed through self-assembly of Fe/Ca-catechin and the formation of a dense interfacial layer around the hydrophobic polyphenol through interfacial cohesion terminate further aggregation and adsorption of the hydrophobic polyphenol particles, resulting in smaller and uniformly dispersed nanoparticles. At the same time, due to the coating of the supramolecular structure, direct contact between light, heat, and the hydrophobic polyphenols is prevented, reducing the loss of hydrophobic polyphenol during delivery and significantly improving the bioavailability of the hydrophobic polyphenol. Furthermore, catechin, as a functional polyphenol, synergistically interacts with the hydrophobic polyphenol, further enhancing the antioxidant properties of the nanoparticles. Fe/Ca, as trace elements non-covalently bound to catechin, reduce metal toxicity and delay the decomposition rate of catechin, enabling the hydrophobic polyphenol to exhibit long-lasting functional activity. The present invention utilizes supramolecules to coat the hydrophobic polyphenol such as resveratrol, curcumin, and quercetin, and the results show that the supramolecular structure is suitable for different kinds of hydrophobic polyphenols.
2. By loading the coated hydrophobic polyphenol nanoparticles into pectin gel, and binding them through complexation and electrostatic interactions, the gel network structure of the pectin gel is enhanced, successfully developing a hydrophobic polyphenol plant-based dietary gel with long-term stability.

Specifically, the hydrophobic polyphenol nanoparticles, protected by the supramolecular coating, are unaffected by conditions such as temperature, pH, and salt ions during the preparation process. The cationic species such as Ca and Fe in the supramolecular structure can bind to pectin through complexation and electrostatic interactions to form a water-resistant network structure resembling an “eggshell,” further entrapping the nanoparticles within its network. This provides long-term stability to the hydrophobic polyphenol during storage and enhances their activity when consumed. The nanoscale polyphenol has higher human absorption efficiency and significantly improved bioavailability. On the other hand, the crosslinking of cations with pectin enhances the network structure and mechanical properties of the pectin gel, addressing issues such as easy collapse and adhesion during storage, resulting in a more stable and intact product structure. Furthermore, the presence of Fe/Ca metal ions also supplements minerals for human nutrition, enhancing the nutritional value of the gel and providing a dual nutritional benefit of supplementing both active polyphenols and mineral components in the dietary gel. The development of dietary gels enriches the variety of dietary supplements and broadens the application direction of nutrient delivery.

### BRIEF DESCRIPTION OF THE DRAWINGS

FIG. 1 displays scanning electron microscope images of supramolecular-coated hydrophobic polyphenol nanoparticles prepared in the examples and comparative examples of the present invention;

FIGS. 2a and 2b respectively show the antioxidant activity of supramolecular-coated hydrophobic polyphenol nanoparticles and pectin gels prepared in the examples and comparative examples of the present invention;

FIGS. 3a and 3b present the storage stability of supramolecular-coated hydrophobic polyphenol nanoparticles and pectin gels prepared in the examples and comparative examples of the present invention;

FIG. 4 displays the mechanical strength of pectin gels prepared in the examples and comparative examples of the present invention.

### DETAILED DESCRIPTION OF THE INVENTION

The following is a detailed elaboration of the examples of the present invention to facilitate researchers in the field to understand the content and characteristics of the invention, thereby providing a more detailed definition of the scope of protection of the invention. However, the invention is not limited to the following examples.

Sources of raw materials used in the examples and comparative examples:
Resveratrol: ≥99%, purchased from Shanghai Ean Chemical Technology Co., Ltd.;
Curcumin: ≥99%, purchased from Shanghai Yuanye Bio-Technology Co., Ltd.;
Quercetin: ≥99%, purchased from Shanghai Yuanye Bio-Technology Co., Ltd.;
Polyvinylpyrrolidone (PVP): AR grade, purchased from Shanghai Aladdin Biochemical Technology Co., Ltd.;
Catechin: ≥98%, purchased from Shaanxi Ruimao Biotechnology Co., Ltd.;
Ethylenediaminetetraacetic acid ferric sodium salt: AR grade, purchased from Shanghai Macklin Biochemical Co., Ltd.;
Calcium Chloride: AR grade, purchased from Sinopharm Chemical Reagent Co., Ltd.;
High-methoxyl pectin: Food grade, purchased from Shandong Zhongtian Biotechnology Co., Ltd.;
Glucose: ≥99%, purchased from Mirai Experimental Equipment Co., Ltd.;
White sugar: AR grade, purchased from Sinopharm Chemical Reagent Co., Ltd.;
Citric acid: ≥99%, purchased from Shanghai Yuanye Bio-Technology Co., Ltd.;
Anhydrous ethanol: ≥99%, purchased from Sinopharm Chemical Reagent Co., Ltd.

### Example 1

(1) 0.02 g of resveratrol powder was weighed and dissolved in 2 mL of anhydrous ethanol to obtain a resveratrol-ethanol solution. 0.03 g of PVP powder was dissolved in 100 mL of water to obtain a PVP aqueous solution. Under a constant stirring speed of 500 rpm, the resveratrol-ethanol solution was injected into the PVP aqueous solution and stirred continuously for 5 minutes to obtain a resveratrol nanoparticle suspension. The feeding ratio of resveratrol, ethanol, PVP, and water was 0.02 g:2 mL:0.03 g:100 mL.
(2) 0.08 g of catechin powder was dissolved in 2 mL of water to obtain a catechin solution with a concentration of 40 mg/mL. 0.02 g of ethylenediaminetetraacetic acid ferric sodium salt powder was dissolved in 2 mL of water to obtain a ethylenediaminetetraacetic acid ferric sodium salt solution with a concentration of 10 mg/mL. The catechin solution and the ethylenediaminetetraacetic acid ferric sodium salt solution were then rapidly injected into the nanoparticle suspension obtained in step (1) under constant ultrasonic action. The feeding ratio of the catechin aqueous solution, the ethylenediaminetetraacetic acid ferric sodium salt aqueous solution, and the resveratrol nanoparticle suspension was 2 mL:2 mL:100 mL.
(3) Using high-purity water as the dispersing agent and maintaining a rotational speed of 1000 rpm, the nanoparticles were subjected to three cycles of centrifugation/redispersion to wash for 10 min. The precipitate was then redispersed in 100 mL of high-purity water to obtain a coated hydrophobic polyphenol nanoparticle suspension.
(4) 3 g of high-methoxyl pectin was slowly added to 30 mL of the coated hydrophobic polyphenol nanoparticle solution obtained in step (3) and allowed to dissolve. It was then stirred in an 85° C. water bath for 20 minutes to obtain a pectin mixture with a pectin concentration of 0.1 g/mL. Meanwhile, 20 g of glucose and 10 g of white sugar were dissolved in a beaker containing 10 mL of pure water and heated on an electronic universal stove padded with an asbestos net at 55° C. until bubbling occurred, and then cooled for later use. The composite sweetener solution was added to the prepared pectin mixture and mixed uniformly. The feeding ratio of high-methoxyl pectin, the coated hydrophobic polyphenol nanoparticle solution, glucose, white sugar, and water was 3 g:30 mL:20 g:10 g:10 mL.
(5) Citric acid was weighed and slowly added to the pectin mixture obtained in step (4) to adjust the pH to between 2 and 3. After uniform mixing, it was poured into a mold for gel formation, and a functional pectin gel was obtained.

### Example 2

(1) 0.02 g of curcumin powder was weighed and dissolved in 2 mL of anhydrous ethanol to obtain a curcumin-ethanol solution. 0.03 g of PVP powder was dissolved in 100 mL of water to obtain a PVP aqueous solution. Under a constant stirring speed of 500 rpm, the curcumin-ethanol solution was injected into the PVP aqueous solution and stirred continuously for 5 minutes to obtain a curcumin nanoparticle suspension. The feeding ratio of curcumin, ethanol, PVP, and water was 0.02 g:2 mL:0.03 g:100 mL.
(2) 0.08 g of catechin powder was dissolved in 2 mL of water to obtain a catechin solution with a concentration of 40 mg/mL. 0.02 g of ethylenediaminetetraacetic acid ferric sodium salt powder was dissolved in 2 mL of water to obtain a ethylenediaminetetraacetic acid ferric sodium salt solution with a concentration of 10 mg/mL. The catechin solution and the ethylenediaminetetraacetic acid ferric sodium salt solution were then rapidly injected into the nanoparticle suspension obtained in step (1) under constant ultrasonic action. The feeding ratio of the catechin aqueous solution, the ethylenediaminetetraacetic acid ferric sodium salt aqueous solution, and the curcumin nanoparticle suspension was 2 mL:2 mL:100 mL.
(3) Using high-purity water as the dispersing agent and maintaining a rotational speed of 1000 rpm, the nanoparticles were subjected to three cycles of centrifugation/redispersion to wash for 10 min. The precipitate was then redispersed in 100 mL of high-purity water to obtain a coated hydrophobic polyphenol nanoparticle suspension.
(4) 3 g of high-methoxyl pectin was slowly added to 30 mL of the coated hydrophobic polyphenol nanoparticle solution obtained in step (3) and allowed to dissolve. It was then stirred in an 85° C. water bath for 20 minutes to obtain a pectin mixture with a pectin concentration of 0.1 g/mL. Meanwhile, 20 g of glucose and 10 g of white sugar were dissolved in a beaker containing 10 mL of pure water and heated on an electronic universal stove padded with an asbestos net at 55° C. until bubbling occurred, and then cooled for later use. The composite sweetener solution was added to the prepared pectin mixture and mixed uniformly. The feeding ratio of high-methoxyl pectin, the coated hydrophobic polyphenol nanoparticle solution, glucose, white sugar, and water was 3 g:30 mL:20 g:10 g:10 mL.
(5) Citric acid was weighed and slowly added to the pectin mixture obtained in step (4) to adjust the pH to between 2 and 3. After uniform mixing, it was poured into a mold for gel formation, and a functional pectin gel was obtained.

### Example 3

(1) 0.02 g of quercetin powder was weighed and dissolved in 2 mL of anhydrous ethanol to obtain a quercetin-ethanol solution. 0.03 g of PVP powder was dissolved in 100 ml of water to produce a PVP aqueous solution. The quercetin-ethanol solution was then injected into the PVP aqueous solution under a constant stirring speed of 500 rpm and stirred continuously for 5 minutes to obtain a quercetin nanoparticle suspension. The feeding ratio of quercetin, ethanol, PVP, and water was 0.02 g:2 mL:0.03 g:100 mL.
(2) 0.08 g of catechin powder was weighed and dissolved in 2 mL of water to produce a catechin solution with a concentration of 40 mg/mL. 0.02 g of ethylenediaminetetraacetic acid ferric sodium salt powder was dissolved in 2 mL of water to obtain a solution with a concentration of 10 mg/mL. The catechin solution and the ethylenediaminetetraacetic acid ferric sodium salt solution were rapidly injected into the nanoparticle suspension obtained in step (1) under constant ultrasonic action. The feeding ratio of the catechin aqueous solution, the ethylenediaminetetraacetic acid ferric sodium salt aqueous solution, and the quercetin nanoparticle suspension was 2 mL:2 mL:100 mL.
(3) Using high-purity water as the dispersing agent and maintaining a rotational speed of 1000 rpm, the nanoparticles were subjected to three cycles of centrifugation/redispersion to wash for 10 min. The precipitate was then redispersed in 100 mL of high-purity water to produce a coated hydrophobic polyphenol nanoparticle suspension.
(4) 3 g of high-methoxyl pectin was slowly added to 30 mL of the coated hydrophobic polyphenol nanoparticle solution obtained in step (3) and allowed to dissolve. The mixture was stirred in an 85° C. water bath for 20 minutes to obtain a pectin mixture with a concentration of 0.1 g/mL. Meanwhile, 20 g of glucose and 10 g of white sugar were dissolved in a beaker containing 10 mL of pure water and heated on an electronic universal stove padded with an asbestos net at 55° C. until bubbling occurred, then cooled for later use. The composite sweetener solution was added to the prepared pectin mixture and mixed uniformly. The feeding ratio of high-methoxyl pectin, the coated hydrophobic polyphenol nanoparticle solution, glucose, white sugar, and water was 3 g:30 mL:20 g:10 g:10 mL.
(5) Citric acid was weighed and slowly added to the pectin mixture obtained in step (4) to adjust the pH to between 2 and 3. After uniform mixing, the mixture was poured into a mold for gel formation, and a functional pectin gel was obtained.

### Comparative Example 1

Compared with Example 1, the surface of resveratrol was not coated.
(1) 0.02 g of resveratrol powder was weighed and dissolved in 2 mL of anhydrous ethanol to obtain a resveratrol-ethanol solution. 0.03 g of PVP powder was dissolved in 100 ml of water to produce a PVP aqueous solution. The resveratrol-ethanol solution was then injected into the PVP aqueous solution under a constant stirring speed of 500 rpm and stirred continuously for 5 minutes to obtain a resveratrol nanoparticle suspension. The feeding ratio of resveratrol, ethanol, PVP, and water was 0.02 g:2 mL:0.03 g:100 mL.
(2) 3 g of high-methoxyl pectin was slowly added to 30 mL of the resveratrol nanoparticle suspension obtained in step (1) and allowed to dissolve. The mixture was stirred in an 85° C. water bath for 20 minutes to obtain a pectin mixture with a concentration of 0.1 g/mL. Meanwhile, 20 g of glucose and 10 g of white sugar were dissolved in a beaker containing 10 mL of pure water and heated on an electronic universal stove padded with an asbestos net at 55° C. until bubbling occurred, then cooled for later use. The composite sweetener solution was then added to the prepared pectin mixture and mixed uniformly. The feeding ratio of high-methoxyl pectin, resveratrol nanoparticle suspension, glucose, white sugar, and water was 3 g:30 mL:20 g:10 g:10 mL.
(3) Citric acid was weighed and slowly added to the pectin mixture obtained in step (2) to adjust the pH to between 2 and 3. After uniform mixing, the mixture was poured into a mold for gel formation, and a functional pectin gel was obtained.

### Comparative Example 2

Compared with Example 1, supermolecular was not added to coat resveratrol nanoparticles.
(1) 3 g of high-methoxyl pectin was slowly added to 30 mL of water and allowed to dissolve. The mixture was stirred in an 85° C. water bath for 20 minutes to obtain a pectin solution with a concentration of 0.1 g/mL. Meanwhile, 20 g of glucose and 10 g of white sugar were dissolved in a beaker containing 10 mL of pure water and heated on an electronic universal stove padded with an asbestos net at 55° C. until bubbling occurred, then cooled for later use. The composite sweetener solution was then added to the prepared pectin solution and mixed uniformly. The feeding ratio of high-methoxyl pectin, glucose, white sugar, water was 3 g:20 g:10 g:40 mL.
(2) Citric acid was weighed and slowly added to the pectin solution obtained in step (1) to adjust the pH to between 2 and 3. After uniform mixing, the mixture was poured into a mold for gel formation, and a functional pectin gel was obtained.

### Comparative Example 3

Compared with Example 1, calcium ion-catechin supermolecular was used to coat resveratrol.
(1) 0.02 g of resveratrol powder was weighed and dissolved in 2 mL of anhydrous ethanol to obtain a resveratrol-ethanol solution. 0.03 g of PVP powder was dissolved in 100 ml of water to produce a PVP aqueous solution. The resveratrol-ethanol solution was then injected into the PVP aqueous solution under a constant stirring speed of 500 rpm and stirred continuously for 5 minutes to obtain a resveratrol nanoparticle suspension. The feeding ratio of resveratrol, ethanol, PVP, and water was 0.02 g:2 mL:0.03 g:100 mL.
(2) 0.08 g of catechin powder was dissolved in 2 mL of water to obtain a catechin solution with a concentration of 40 mg/mL. 0.02 g of calcium chloride powder was dissolved in 2 mL of water to produce a calcium chloride solution with a concentration of 10 mg/mL. The catechin solution and calcium chloride solution were then rapidly injected into the nanoparticle suspension obtained in step (1) under constant ultrasonic action. The feeding ratio of catechin aqueous solution, calcium chloride aqueous solution, and resveratrol nanoparticle suspension was 2 mL:2 mL:100 mL.
(3) Using high-purity water as the dispersing agent and maintaining a rotational speed of 1000 rpm, the nanoparticles were subjected to three cycles of centrifugation/redispersion to wash for 10 min. The precipitate was then redispersed in 100 mL of high-purity water to obtain a suspension of coated hydrophobic polyphenol nanoparticles.
(4) 3 g of high-methoxyl pectin was slowly added to 30 mL of the coated hydrophobic polyphenol nanoparticle suspension obtained in step (3) and allowed to dissolve. The mixture was stirred in an 85° C. water bath for 20 minutes to obtain a pectin mixture with a concentration of 0.1 g/mL. Meanwhile, 20 g of glucose and 10 g of white sugar were dissolved in a beaker containing 10 mL of pure water and heated on an electronic universal stove padded with an asbestos net at 55° C. until bubbling occurred, then cooled for later use. The composite sweetener solution was then added to the prepared pectin mixture and mixed uniformly. The feeding ratio of high-methoxyl pectin, the coated hydrophobic polyphenol nanoparticle suspension, glucose, white sugar, and water was 3 g:30 mL:20 g:10 g:10 mL.
(5) Citric acid was weighed and slowly added to the pectin mixture obtained in step (4) to adjust the pH to between 2 and 3. After uniform mixing, the mixture was poured into a mold for gel formation, and a functional pectin gel was obtained.

The testing methods for the nanoparticles and gels prepared in the examples and comparative examples of this invention are as follows:

### (1) Scanning Electron Microscope (SEM) Analysis

The morphology of the composite nanoparticles was observed using FE-SEM (HITACHI Regulus 8100, Japan). All samples were measured at an acceleration voltage of 10 kV after being coated with gold.

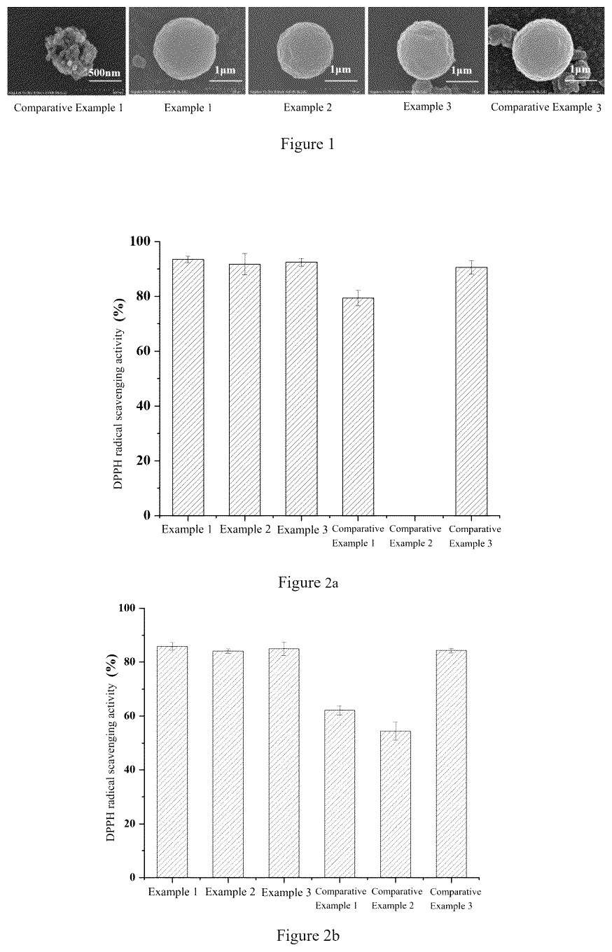

The results are shown in FIG. 1:

The results indicate that the hydrophobic nanoparticles exhibited a spherical shape, were relatively small in size, and underwent self-aggregation. After the addition of catechin-metal supramolecular structure, the surface morphology of the nanoparticles appeared fused, with larger and irregular particles, suggesting that the supramolecular structure was successfully coated onto the surface of the hydrophobic nanoparticles.

### (2) Antioxidant Activity

DPPH Radical Scavenging Experiment: The DPPH radical scavenging activity was assessed using a kit from Nanjing Jiancheng Bioengineering Institute. For the nanoparticles, the detection method was as follows: 100 μL of the sample solution was taken and placed in a microplate, and 100 μL of 0.01 mmol/L DPPH-methanol solution was added and mixed well. After reacting in the dark at room temperature for 30 minutes, the absorbance (A) was measured at 517 nm. A sample control (A0) was set up by replacing the DPPH-methanol solution with 100 μL of anhydrous methanol, and a blank control (A1) was set up by replacing the sample solution with 100 μL of anhydrous methanol. For the gels, the detection method was as follows: Approximately 1 g of solid sample was weighed and added to 10 mL of methanol solution. The mixture was sheared at a speed of 12,000 rpm for 3 minutes and then centrifuged at 1,200 rpm for 10 minutes. The supernatant sample was taken for testing. 100 μL of the supernatant sample was placed in a microplate, and 100 μL of 0.01 mmol/L DPPH-methanol solution was added and mixed well. After reacting in the dark at room temperature for 30 minutes, the absorbance (A) was measured at 517 nm. A sample control (A0) was set up by replacing the DPPH-methanol solution with 100 μL of anhydrous methanol, and a blank control (A1) was set up by replacing the sample solution with 100 μL of anhydrous methanol. The percentage of DPPH radical scavenging activity was calculated using the following formula:

$$DPPH radical scavenging activity ( \% ) = [ 1 - \frac{( A - {A}_{1} )}{{A}_{0}} ] \times 100$$

The results are shown in FIGS. 2a and 2b:

The results indicate that, as seen in FIGS. 2a and 2b, the DPPH radical scavenging activity of the nanoparticles coated with supramolecular structure was significantly improved. Correspondingly, the DPPH radical scavenging capacity of the gel products was also significantly higher than that of pure pectin gels and gels made from hydrophobic polyphenol nanoparticles. This was due to the coating effect of the supramolecular structure, which facilitated the uniform dispersion of the hydrophobic polyphenol nanoparticles in aqueous solutions, thereby enhancing their solubility and bioactivity. Additionally, catechin, as a natural antioxidant, could exert synergistic antioxidant effects with hydrophobic polyphenols, further improving the antioxidant activity.

### (3) Storage Stability

The storage stability of encapsulated hydrophobic polyphenol nanoparticles and functional pectin gels was reflected by the encapsulation efficiency of the hydrophobic polyphenol. For the nanoparticles, the detection method was as follows: The coated hydrophobic polyphenol nanoparticle solution was diluted to 1 mg/mL, and 10 mL of it was centrifuged at 9,000 rpm for 20 minutes. Then, 5 mL of the supernatant after centrifugation was transferred to a 25 mL volumetric flask and diluted to volume with deionized water. The absorbance value was measured using a UV-Vis spectrophotometer at 306 nm. For the gels, the detection method was as follows: Approximately 1 g of solid sample was weighed and added to 10 mL of water. The mixture was sheared at a speed of 12,000 rpm for 3 minutes and then centrifuged at 9,000 rpm for 20 minutes. Subsequently, 5 mL of the supernatant after centrifugation was transferred to a 25 mL volumetric flask and diluted to volume with deionized water. The absorbance value was measured using a UV-Vis spectrophotometer at 306 nm. Finally, based on the plotted standard curve of the hydrophobic polyphenol and the dilution factor, the coated hydrophobic polyphenol nanoparticles were stored for 28 days, and the amount of free hydrophobic polyphenol was detected every 7 days to calculate the free resveratrol content in the supernatant. The encapsulation efficiency of resveratrol was calculated using the following formula:

$$encapsulation efficiency ( \% ) = \frac{\begin{matrix}total amount of hydrophobic polyphenol - \\ amount of free hydrophobic polyphenol\end{matrix}}{total amont of hydrophobic polyphenol} \times 100$$

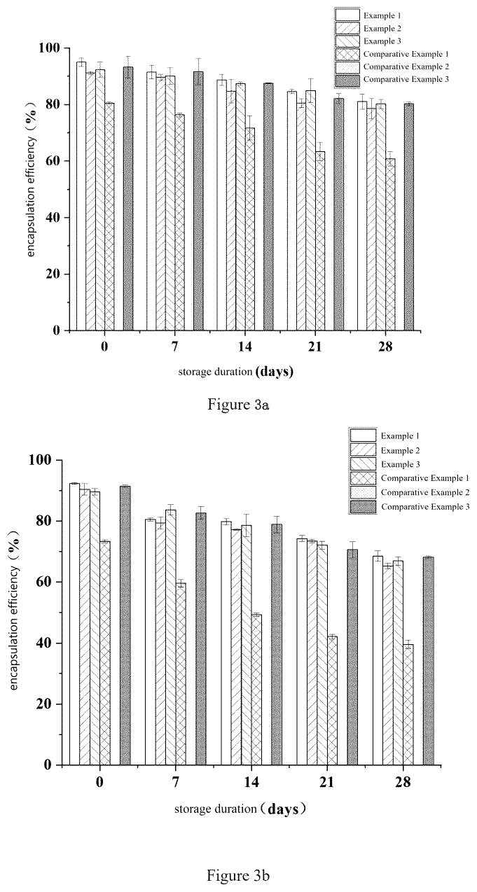

The results are shown in FIGS. 3a and 3b:

The results indicate that, as seen in FIGS. 3a and 3b, with the extension of storage duration, the content of the active ingredient in all examples and comparative examples gradually decreased. However, the content of hydrophobic polyphenol in the nanoparticles coated with supramolecular structure was significantly higher than that in pure hydrophobic polyphenol nanoparticles. This was due to the excellent protection provided to the hydrophobic polyphenol nanoparticles by the supramolecular structure, which, in combination with the synergistic activation effect of catechin, slowed down the degradation of the polyphenol. Additionally, the coating of the supramolecular structure created a “protective film” on the surface of the hydrophobic polyphenol nanoparticles, enhancing their long-term stability.

### (4) Mechanical Strength of the Gel

The hardness of the pectin gels was tested using a texture analyzer (TA-TX Plus, Stable Microsystem Ltd.). A cylindrical flat-ended probe (P/2) with a diameter of 2 mm was used to compress the gels at a downward pressure of 10.00 mm/s, with a depth of 8.00 mm and a contact force of 5 g. A force-time relationship curve was automatically generated, and the highest peak of the curve was taken as the hardness value. Each sample was measured three times, and the average value was calculated.

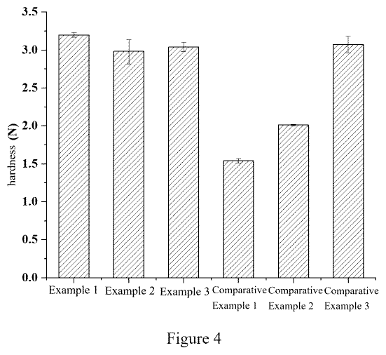

The results are shown in FIG. 4:

The results indicate that the hardness of the gel products with the addition of supramolecular-coated hydrophobic polyphenol nanoparticles was significantly increased. There was no significant difference in hardness between the pure pectin gel and the pectin gel with the addition of resveratrol nanoparticles. However, in the supramolecular-coated hydrophobic polyphenol nanoparticle gel, the presence of metal ions crosslinked with pectin to form a network structure, which enhanced the mechanical properties of the pectin while also achieving the effect of nutrient delivery.

1. A preparation method for coated hydrophobic polyphenol nanoparticles, characterized in that the preparation method includes the following steps:
(1) injecting an ethanol solution of a hydrophobic polyphenol into an aqueous solution of PVP, and stirring thoroughly to obtain a suspension of hydrophobic polyphenol nanoparticles; wherein the feeding mass ratio of the hydrophobic polyphenol to PVP is 1:1.5;
(2) rapidly injecting an aqueous solution of catechin with a concentration of 40-50 mg/mL and an aqueous solution of metal salt with a concentration of 10-15 mg/mL into the suspension of hydrophobic polyphenol nanoparticles obtained in step (1) under ultrasonic condition to obtain a suspension of composite nanoparticles; wherein the metal salt is ethylenediaminetetraacetic acid ferric sodium salt or calcium chloride, the feeding ratio of the aqueous solution of catechin, the aqueous solution of metal salt, and the suspension of hydrophobic polyphenol nanoparticles is calculated based on the mass ratio of catechin, the metal salt, and the hydrophobic polyphenol contained therein, which is 4-5:1-1.5:1;
(3) using high-purity water as the dispersing agent, subjecting the suspension of composite nanoparticles obtained in step (2) to cyclic treatment through centrifugation/redispersion to remove excess catechin and metal ions; then redispersing the obtained precipitate in high-purity water to obtain a suspension of coated hydrophobic polyphenol nanoparticles, namely, a suspension of catechin-metal supramolecular coated hydrophobic polyphenol nanoparticles.

2. The preparation method according to claim 1, characterized in that the hydrophobic polyphenol is resveratrol, curcumin, or quercetin.

3. The preparation method according to claim 1, characterized in that in step (1), the concentration of the ethanol solution of the hydrophobic polyphenol is 10-12 mg/mL; and the concentration of the aqueous solution of PVP is 0.3-0.5 mg/mL.

4. Coated hydrophobic polyphenol nanoparticles obtained by the preparation method according to claim 1.

5. An application of the coated hydrophobic polyphenol nanoparticles according to claim 4 in the preparation of a pectin gel, including the following steps:
(a) adding pectin to the suspension of coated hydrophobic polyphenol nanoparticles for dissolution to obtain a mixture;
(b) preparing an aqueous solution of sweetener;
(c) mixing the mixture prepared in step (a) with the aqueous solution of the sweetener prepared in step (b) evenly, adding citric acid dropwise to adjust the pH to between 2 and 3, mixing uniformly, and pouring the mixture into a mold for gel formation to obtain a pectin gel containing coated hydrophobic polyphenol nanoparticles.

6. The application according to claim 5, characterized in that the pectin is high-methoxyl pectin.

7. The application according to claim 5, characterized in that the feeding ratio of pectin to coated hydrophobic polyphenol nanoparticles is calculated based on the mass ratio of pectin to the hydrophobic polyphenol contained in the coated hydrophobic polyphenol nanoparticles, which is 3:0.006-0.015.

8. The application according to claim 5, characterized in that the sweetener is a combination of glucose and white sugar, with a mass ratio of 1:0.5-0.75.

9. The application according to claim 5, characterized in that the feeding ratio of the mixture prepared in step (a) to the aqueous solution of sweetener prepared in step (b) is calculated based on the mass ratio of pectin to sweetener, which is 3:30-45.

10. Coated hydrophobic polyphenol nanoparticles obtained by the preparation method according to claim 2.

11. An application of the coated hydrophobic polyphenol nanoparticles according to claim 10 in the preparation of a pectin gel, including the following steps:
(a) adding pectin to the suspension of coated hydrophobic polyphenol nanoparticles for dissolution to obtain a mixture;
(b) preparing an aqueous solution of sweetener;
(c) mixing the mixture prepared in step (a) with the aqueous solution of the sweetener prepared in step (b) evenly, adding citric acid dropwise to adjust the pH to between 2 and 3, mixing uniformly, and pouring the mixture into a mold for gel formation to obtain a pectin gel containing coated hydrophobic polyphenol nanoparticles.

12. The application according to claim 11, characterized in that the pectin is high-methoxyl pectin.

13. The application according to claim 11, characterized in that the feeding ratio of pectin to coated hydrophobic polyphenol nanoparticles is calculated based on the mass ratio of pectin to the hydrophobic polyphenol contained in the coated hydrophobic polyphenol nanoparticles, which is 3:0.006-0.015.

14. The application according to claim 11, characterized in that the sweetener is a combination of glucose and white sugar, with a mass ratio of 1:0.5-0.75.

15. The application according to claim 11, characterized in that the feeding ratio of the mixture prepared in step (a) to the aqueous solution of sweetener prepared in step (b) is calculated based on the mass ratio of pectin to sweetener, which is 3:30-45.

16. Coated hydrophobic polyphenol nanoparticles obtained by the preparation method according to claim 3.

17. An application of the coated hydrophobic polyphenol nanoparticles according to claim 16 in the preparation of a pectin gel, including the following steps:
(a) adding pectin to the suspension of coated hydrophobic polyphenol nanoparticles for dissolution to obtain a mixture;
(b) preparing an aqueous solution of sweetener;
(c) mixing the mixture prepared in step (a) with the aqueous solution of the sweetener prepared in step (b) evenly, adding citric acid dropwise to adjust the pH to between 2 and 3, mixing uniformly, and pouring the mixture into a mold for gel formation to obtain a pectin gel containing coated hydrophobic polyphenol nanoparticles.

18. The application according to claim 17, characterized in that the pectin is high-methoxyl pectin.

19. The application according to claim 17, characterized in that the feeding ratio of pectin to coated hydrophobic polyphenol nanoparticles is calculated based on the mass ratio of pectin to the hydrophobic polyphenol contained in the coated hydrophobic polyphenol nanoparticles, which is 3:0.006-0.015.

20. The application according to claim 17, characterized in that the sweetener is a combination of glucose and white sugar, with a mass ratio of 1:0.5-0.75.
